(19) United States
(12) Patent Application Publication
(10) Pub. No.: US 2007/0179839 A1
(43) Pub. Date: Aug. 2, 2007

(54) Method and computer program product for redeeming loyalty points in an online raffle

(75) Inventor: Trey L. Neemann, Glendale, AZ (US)

Correspondence Address: STERNE, KESSLER, GOLDSTEIN & FOX P.L.L.C., 1100 NEW YORK AVENUE, N.W., WASHINGTON, DC, 20005, US

(73) Assignee: American Express Marketing & Development Corp., a Delaware Corporation

(21) Appl. No.: 11/256,951

(22) Filed: Oct. 25, 2005

(51) Int. Cl. G06Q 30/00

(52) U.S. Cl. 705/14

(57) ABSTRACT

Methods and computer program products for performing an online auction are described. An embodiment of the present invention provides a computer-based method for performing an online raffle for an item, utilizing loyalty rewards points as currency. The method includes the following. Information about the item is displayed on a website. A request to enter the raffle, including an authorization to redeem a predetermined number of loyalty rewards points, is received from each interested customer. For each interested customer, the predetermined number of loyalty rewards points is redeemed. The interested customer that have the predetermined number of rewards points redeemed are entered as participants in the raffle. A winner is selected from the raffle participants.

### BACKGROUND OF THE INVENTION

1. Field Of The Invention

The present invention generally relates to loyalty rewards programs, and more particularly to increasing customer participation in loyalty rewards programs.

2. Related Art

Loyalty programs are designed to encourage and increase a particular customer behavior by offering a variety of rewards that can be redeemed using accumulated loyalty rewards points. Typically, a customer can redeem her loyalty rewards points for rewards, such as merchandise, gift certificates, charitable donations, cash, or points/miles in a participating partner loyalty program. In a typical redemption scenario, as long as the customer has adequate points, she can redeem a fixed number of loyalty rewards points for a particular reward.

In addition to the typical redemption scenarios mentioned above, sometimes loyalty points are redeemed in a contest. A typical contest in which loyalty points are redeemed is an auction. The basic premise of an auction is that different participants “bid” for an item being offered. After a designated period of time, the high bidder(s) is (are) declared the winner(s) and awarded the item. But this type of contest is biased toward those participants with more currency available. Since more affluent customers can potentially spend more money, and therefore acquire more loyalty points, than less affluent customers, an auction is biased toward the more affluent. In other words, some customers will never be able to participate at the same level as the more affluent customers—which may tend to de-motivate less affluent customers from participating in loyalty rewards programs and may serve to limit the number of participants in these loyalty rewards programs.

Given the foregoing, what is needed is a method and computer program product for redeeming loyalty points in an online raffle.

### BRIEF DESCRIPTION OF THE INVENTION

The present invention meets the above-identified needs by providing a method and computer program product for redeeming loyalty points in an online raffle.

An embodiment of the present invention provides a computer-based method for performing an online raffle for an item, utilizing loyalty rewards points as currency. The method includes the following: (i) information about the item is displayed on a website; (ii) a request to enter the raffle, including an authorization to redeem a predetermined number of loyalty rewards points, is received from each interested customer; (iii) for each interested customer, the predetermined number of loyalty rewards points is redeemed, wherein each interested customer that has the predetermined number of rewards points redeemed is entered as participants in the raffle; and (iv) a winner is selected from the raffle participants.

An advantage of the present invention is that it provides an online loyalty rewards redemption raffle in which all participants are equally likely to win. Since the online raffle is not biased toward the more affluent customers, this raffle can potentially attract more participants than a typical online auction, and therefore result in an increase in the total number of loyalty rewards points redeemed.

Further features and advantages of the present invention as well as the structure and operation of various embodiments of the present invention are described in detail below with reference to the accompanying drawings.

### BRIEF DESCRIPTION OF THE DRAWINGS

The features and advantages of the present invention will become more apparent from the detailed description set forth below when taken in conjunction with the drawings in which like reference numbers indicate identical or functionally similar elements. Additionally, the left-most digit of a reference number identifies the drawing in which the reference number first appears.

FIG. 1 is a system diagram of an exemplary environment in which the present invention, in an embodiment, would be implemented.

FIG. 2 is a flowchart illustrating a computer-based method for performing an online raffle in accordance with an embodiment of the present invention.

FIG. 3 is a block diagram of an exemplary computer system useful for implementing an embodiment of the present invention.

### DETAILED DESCRIPTION

I. Introduction

The present invention is directed to a method and computer program product for performing an online raffle of an item. As is mentioned above, and described in more detail below, in contrast to most auctions, an online raffle in accordance with an embodiment of the present invention is not biased toward more affluent customers. An item being raffled can be a tangible prize or an “experience.” Examples of a tangible prize can include, but are not limited to, a car, a computer, cash, or the like. Examples of an “experience” can include, but are not limited to, a golfing trip with a famous athlete, dinner with a celebrity, participating in any other outing or activity, or the like.

The terms “user,” “end user,” “consumer,” “customer,” “card members,” and/or “participant,” and/or the plural form of these terms are used interchangeably throughout herein to refer to those persons or entities capable of accessing, using, being affected by and/or benefiting from the tool that the present invention provides for redeeming loyalty points in an online raffle.

Furthermore, the terms “business” or “merchant” may be used interchangeably with each other and shall mean any person, entity, distributor system, software and/or hardware that is a provider, broker and/or any other entity in the distribution chain of goods or services. For example, a merchant may be a grocery store, a retail store, a travel agency, a service provider, an on-line merchant or the like.

It is noted that references in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

The present invention is now described in more detail herein in terms of an exemplary loyalty rewards program developed by American Express Travel Related Services Company, Inc. (“American Express”). This is for convenience only and is not intended to limit the application of the present invention. In fact, after reading the following description, it will be apparent to one skilled in the relevant art(s) how to implement the following invention in alternative embodiments (e.g., using different card issuers, program sponsors and the like).

II. Example System

An example loyalty rewards program is a Membership Rewards® (MR) program provided by American Express. The American Express MR program provides certain card members with an opportunity to establish a MR account which facilitates the earning and collecting of loyalty points. Card members may earn loyalty points from, for example, charging purchases on an American Express transaction card, purchasing certain products at affiliated vendors (e.g., airline tickets), purchasing services from affiliated vendors (e.g., hotel stays), and purchasing products on websites using the charge card account number. MR loyalty points may be used by card members to purchase items, obtain discounts on products or services, or to obtain special upgrades or prizes.

According to an embodiment, the online system allows MR members to participate in an online raffle. In an example, only a subset of all interested customers may participate in the closed auction. The subset can include, for example, card members in good standing who are enrolled in both the MR and Manage Your Card Account (MYCA) programs. In addition, interested customers that are under the age of 21 can be restricted from participating in the closed auction.

“Currency” used for entering the raffle is represented by a balance of loyalty points available in a card member's loyalty account. A card member's previously established MR account can be used to track the loyalty points (currency); hence, an additional account (e.g., a unique raffle account) is not necessarily needed for this purpose. According to an embodiment, the raffle system retrieves pre-existing data from the card member's MR account via online access (e.g., through a MYCA account or similar customer account), and then automatically displays the loyalty point total. In other words, the user is never required or permitted to submit or edit loyalty point balance information that is recorded in the system.

As mentioned above, auctions are inherently biased toward participants having more currency (e.g., more affluent customers, more tenured customers, or the like). In contrast, a raffle provides a contest in which each raffle participant is equally likely to win—i.e., it is not biased toward any particular class of participants. A winner is not determined by an amount being bid, but randomly selected from those participants that enter the raffle.

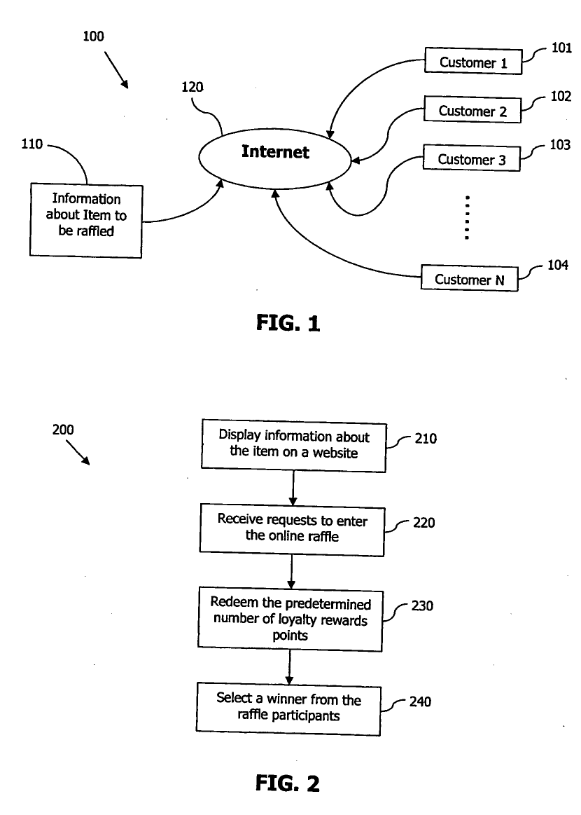

FIG. 1 illustrates a computer-based system 100 for performing an online raffle in accordance with an embodiment of the present invention. System 100 generally shows the Internet 100 to which a customer 1, a customer 2, a customer 3, and a customer N have access. The actual number of customers can be quite large (e.g., hundreds, thousands, or more). As is well-known, these customers can view information displayed on the Internet 120 by using a web browser. An organizer of the online raffle (e.g., American Express) can display information about an item to be raffled (indicated by block 110) on the Internet 120. In this way, the customers can view the information about the item being raffled by the organizer. An example manner in which system 100 is used to implement an online raffle is described below with reference to FIG. 2.

III. Example Method

Referring to FIG. 2, there is shown a flowchart illustrating a computer-based method 200 for performing an online raffle of an item in accordance with an embodiment of the present invention. Loyalty rewards points are used as currency for the online raffle.

Method 200 begins at a step 210 in which information about an item to be raffled is displayed on a website. In this way, as mentioned above with reference to system 100 of FIG. 1, customers can view the information over the Internet using a web browser. The information about the item includes a predetermined number of loyalty points needed to enter the raffle. For example, the predetermined number of loyalty points may be set at 5,000 points for a particular item.

In a step 220, requests to enter the online raffle are received. An interested customer's request to enter the raffle includes an authorization to redeem the predetermined number of loyalty rewards points. For example, if the cost to enter the raffle is 5,000 points, a request includes the interested customer's authorization to redeem 5,000 of his/her loyalty rewards points. As described in more detail below, in one embodiment, an interested customer can send multiple requests to enter the raffle. Each of the multiple requests includes the interested customer's authorization to redeem the predetermined number of loyalty points. So, according to the example presented above, if the interested customer sends five requests, in total the interested customer authorizes the redemption of 25,000 loyalty points (i.e., 5,000 points per request for 5 requests). In another embodiment, each interested customer is limited to only one request.

In a step 230, the predetermined number of loyalty rewards points, from each interested customer, are redeemed. Each interested customer having her loyalty points redeemed is entered as a participant into the raffle. In terms of the example described above, for each interested customer's request, 5,000 points would be redeemed. In this way, if the raffle includes 1,000 participants, the total number of loyalty points redeemed would be 5,000,000 (i.e., 5,000 points per participant for 1,000 participants).

In a step 240, a winner is selected from the raffle participants. For example, the winner can be selected in a random (or pseudo-random) fashion by using, for example, a random (or pseudo-random) number generator as would be apparent to a person skilled in the relevant art(s).

Method 200 can be realized in several different ways, as illustrated below. Each example described below, or combinations thereof, can be included in an online raffle in accordance with an embodiment of the present invention.

As a first example, an online raffle could be “open” to whomever wants to participate. For instance, if 10,000 interested customers want to enter the raffle, they could (provided they had the required points to pledge).

As a second example, a time limit could be set before which all requests to enter the raffle must be received. In this way, the total number of raffle participants would be limited. By decreasing the total number of raffle participants, each raffle participant's probability of winning increases. This would give interested customers incentive to enter the raffle quickly. In addition, a raffle participant's request to enter the raffle can be weighted according to the time the request is received. For example, if the raffle is open for a week, entry requests that are received on the first day could receive two entries rather than one, thereby giving the entrant a higher probability of winning. This would give customers an incentive to enter the raffle earlier rather than later. Other weighting schemes could be used without deviating from the scope of the present invention, as would be apparent to a person skilled in the relevant art(s).

As a third example, the raffle could be limited to the first N entries, where N can be any integer value (e.g., 100, 500, 1,000 or any other integer as would be apparent to persons skilled in the relevant art(s) after reading the description herein). Again, by limiting the total number of raffle participants, each raffle participant's probability of winning improves. This encourages customers to participate sooner rather than later because there are a limited number of entries available. In addition, an interested customer could increase her odds of winning by sending more than one request to enter the raffle (although this would require her to authorize more loyalty points to be redeemed). For instance, if the raffle is limited to the first 1,000 entries and a single interested customer entered the raffle twice, her chances of winning would be 1 in 500; however, if she entered the raffle 10 times, her chances of winning would be 1 in 100. (It is to be appreciated that these odds of winning are based on a randomly selected winner. If the selection process is not exactly random, the odds of winning would be altered.)

As a fourth example, the number of requests could be limited to the first N customers, where N can be any integer value (e.g., 100, 500, 1,000 or some other number as would be apparent to a person skilled in the relevant art(s)). If the raffle contest is limited to the first 1,000 interested customers, each interested customer is only allowed to enter the raffle once-and therefore each raffle participant is equally likely to win. For instance, if the raffle contest is limited to the first 1,000 customers, each raffle participant would have a 1 in 1,000 chance of winning. (As noted above, it is to be appreciated that these odds of winning are based on a randomly selected winner. If the selection process is not exactly random, the odds of winning would be altered.)

In a fifth example, multiple items can be offered as part of a single raffle contest. Instead of a single item, more than one item can be available for the participating customers to win. A multiple item raffle can be realized in at least two ways. First, the multiple items being raffled can be substantially identical to each other. For instance, three different winners can be selected to play a round of golf with a famous athlete, or five winners can be selected to receive a new sports car. In this way, each winner receives a substantially identical prize to each other winner, but the prizes are not identical—e.g., two winners are not selected to win a single car.

As a second manner in which a multiple item raffle can be realized, different tiers of items can be offered. For instance, an online raffle in accordance with an embodiment of the present invention can have a grand prize and one or more smaller, less valuable prize(s). For a single entry, the raffle participant would be eligible to win any one of the items being offered.

As mentioned above, an online raffle in accordance with the present invention requires all interested customers to redeem a predetermined number of loyalty points (e.g., 500 points) in order to enter the raffle. Since most of the raffle participants will not win, most of the raffle participants will receive nothing in return for redeeming their loyalty points. However, embodiments of the present invention provide incentives for customers to enter the raffle—even those raffle participants who do not win the raffle.

For example, at least a portion of the monetary equivalent of the loyalty points redeemed by each interested customer used to enter the raffle can be donated to a charity. By donating to a charity, each interested customer receives incentive (in the form of goodwill) for entering the raffle. Using an example from above, if 1,000 customers enter into a raffle for 5,000 points each, 5,000,000 points could be donated to a designated charity. If each loyalty point has an equivalent monetary value of, e.g., $0.02, then a total of $100,000 could be donated to the designated charity.

As another example for creating incentive for interested customers, each raffle participant could be provided with an entry prize. Example entry prizes can include, a gift certificate, a merchant coupon or the like. This approach could be extended so that only a select number of the raffle participants receive a consolation prizes. For instance, the raffle could be open to 1,000 raffle participants, with only 100 of the 1,000 being eligible for a consolation prize.

IV. Example Implementations

Embodiments of the present invention (e.g., system 100, method 200 or any part(s) or function(s) thereof) may be implemented using hardware, software or a combination thereof and may be implemented in one or more computer systems or other processing systems. However, manipulations performed by the present invention were often referred to in terms, such as receiving or selecting, which are commonly associated with mental operations performed by a human operator. No such capability of a human operator is necessary, or desirable in most cases, in any of the operations described herein which form part of the present invention. Rather, the operations are usually machine operations. Useful machines for performing the operation of the present invention include general purpose digital computers or similar devices.

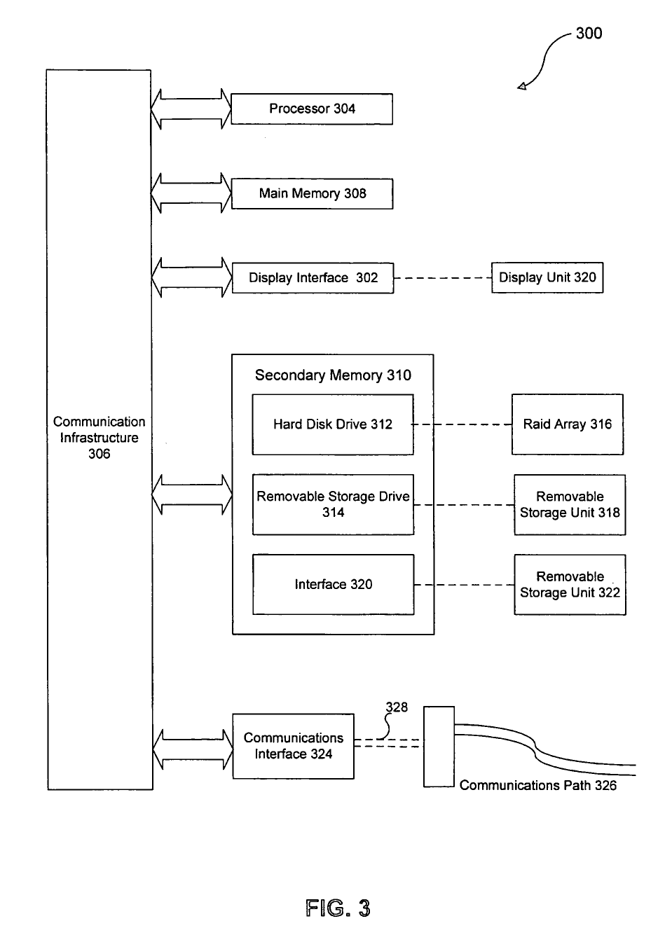

In fact, in one embodiment, the invention is directed toward one or more computer systems capable of carrying out the functionality described herein. An example of a computer system 300 is shown in FIG. 3.

The computer system 300 includes one or more processors, such as processor 304. The processor 304 is connected to a communication infrastructure 306 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 300 can include a display interface 302 that forwards graphics, text, and other data from the communication infrastructure 306 (or from a frame buffer not shown) for display on the display unit 330.

Computer system 300 also includes a main memory 308, preferably random access memory (RAM), and may also include a secondary memory 310. The secondary memory 310 may include, for example, a hard disk drive 312 and/or a removable storage drive 314, representing a floppy disk drive, a magnetic tape drive, an optical disk drive, etc. The removable storage drive 314 reads from and/or writes to a removable storage unit 318 in a well known manner. Removable storage unit 318 represents a floppy disk, magnetic tape, optical disk, etc. which is read by and written to by removable storage drive 314. As will be appreciated, the removable storage unit 318 includes a computer usable storage medium having stored therein computer software and/or data.

In alternative embodiments, secondary memory 310 may include other similar devices for allowing computer programs or other instructions to be loaded into computer system 300. Such devices may include, for example, a removable storage unit 322 and an interface 320. Examples of such may include a program cartridge and cartridge interface (such as that found in video game devices), a removable memory chip (such as an erasable programmable read only memory (EPROM), or programmable read only memory (PROM)) and associated socket, and other removable storage units 322 and interfaces 320, which allow software and data to be transferred from the removable storage unit 322 to computer system 300.

Computer system 300 may also include a communications interface 324. Communications interface 324 allows software and data to be transferred between computer system 300 and external devices. Examples of communications interface 324 may include a modem, a network interface (such as an Ethernet card), a communications port, a Personal Computer Memory Card International Association (PCMCIA) slot and card, etc. Software and data transferred via communications interface 324 are in the form of signals 328 which may be electronic, electromagnetic, optical or other signals capable of being received by communications interface 324. These signals 328 are provided to communications interface 324 via a communications path (e.g., channel) 326. This channel 326 carries signals 328 and may be implemented using wire or cable, fiber optics, a telephone line, a cellular link, an radio frequency (RF) link and other communications channels.

In this document, the terms “computer program medium” and “computer usable medium” are used to generally refer to media such as removable storage drive 314, a hard disk installed in hard disk drive 312, and signals 328. These computer program products provide software to computer system 300. The invention is directed to such computer program products.

Computer programs (also referred to as computer control logic) are stored in main memory 308 and/or secondary memory 310. Computer programs may also be received via communications interface 324. Such computer programs, when executed, enable the computer system 300 to perform the features of the present invention, as discussed herein. In particular, the computer programs, when executed, enable the processor 304 to perform the features of the present invention. Accordingly, such computer programs represent controllers of the computer system 300.

In an embodiment where the invention is implemented using software, the software may be stored in a computer program product and loaded into computer system 300 using removable storage drive 314, hard drive 312 or communications interface 324. The control logic (software), when executed by the processor 304, causes the processor 304 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

VI. Conclusion

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. Thus, the present invention should not be limited by any of the above described exemplary embodiments, but should be defined only in accordance with the following claims and their equivalents.

In addition, it should be understood that the figures illustrated in the attachments, which highlight the functionality and advantages of the present invention, are presented for example purposes only. The architecture of the present invention is sufficiently flexible and configurable, such that it may be utilized (and navigated) in ways other than that shown in the accompanying figures.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

What is claimed is:

1. A computer-based method for performing an online raffle for an item, utilizing loyalty rewards points as currency, the method comprising the steps of:
(a) displaying information about the item on a website, thereby allowing customers to view the information over the Internet using a web browser;
(b) receiving, from each interested customer, a request to enter the raffle including an authorization to redeem a predetermined number of loyalty rewards points;
(c) redeeming, from a loyalty points account associated with each interested customer, the predetermined number of loyalty rewards points, and entering each interested customer as a participant in the raffle; and
(d) selecting a winner from among the raffle participants.

2. The method of claim 1, wherein step (d) comprises one of:
pseudo-randomly and randomly selecting the winner from among the raffle participants.

3. The method of claim 1, further comprising:
(e) sending to a charity a monetary equivalent of at least a subset of the predetermined number of loyalty rewards points that are redeemed in step (c).

4. The method of claim 1, further comprising:
(e) selecting a subset of the raffle participants, each raffle participant in the subset to receive a consolation prize.

5. The method of claim 4, wherein step (e) comprises one of:
pseudo-randomly and randomly selecting the subset of the raffle participants.

6. The method of claim 1, further comprising:
(e) designating each raffle participant to receive an entry prize for entering the raffle.

7. The method of claim 1, wherein step (c) further comprises:
entering as raffle participants only interested customers that send the request to enter the raffle within a predetermined period of time.

8. The method of claim 7, further comprising:
weighting a raffle participant's entry based on when the participant's entry request is received.

9. The method of claim 1, wherein steps (b) and (c) comprise:
(b) receiving, from each of a limited number of interested customers, a request to enter the raffle including an authorization to redeem a predetermined number of loyalty rewards points; and
(c) redeeming, from a loyalty points account associated with each of the limited number of interested customers, the predetermined number of loyalty rewards points, and entering each of the limited number of interested customers as a participant in the raffle.

10. The method of claim 1, wherein step (b) comprises:
(b) receiving, from each interested customer, one request to enter the raffle including an authorization to redeem a predetermined number of loyalty rewards points.

11. The method of claim 1, wherein:
(b1) step (b) comprises receiving from one or more interested customers, a plurality of requests to enter the raffle, including an authorization to redeem a predetermined number of loyalty reward points for each request; and
(c1) step (c) comprises redeeming the predetermined number of loyalty rewards points for each request made according to step (b1), and entering each interested customer as a participant in the raffle a plurality of times corresponding to the plurality of requests.

12. A computer program product comprising a computer usable medium having control logic stored therein for causing a computer to perform an online raffle of an item, utilizing loyalty rewards points as currency, the control logic comprising:
first computer readable program code means for causing the computer to display information about the item on a website, thereby allowing customers to view the information over the Internet using a web browser;
second computer readable program code means for causing the computer to receive, from each interested customer, a request to enter the raffle including an authorization to redeem a predetermined number of loyalty rewards points;
third computer readable program code means for causing the computer to redeem, from a loyalty points account associated with each interested customer, the predetermined number of loyalty rewards points, and entering each interested customer as a participant in the raffle; and
fourth computer readable program code means for causing the computer to select a winner from among the raffle participants.

13. The computer program product of claim 12, wherein the fourth computer readable program code comprises:
means for causing the computer to one of pseudo-randomly and randomly select the winner from among the raffle participants.

14. The computer program product of claim 12, further comprising:
fifth computer readable program code means for causing the computer to send to a charity a monetary equivalent of at least a subset of the predetermined number of loyalty rewards points that are redeemed by the third computer readable program code.

15. The computer program product of claim 12, further comprising:
fifth computer readable program code means for causing the computer to select a subset of the raffle participants, each raffle participant in the subset to receive a consolation prize.

16. The computer program product of claim 12, further comprising:
fifth computer readable program code means for causing the computer to designate each raffle participant to receive an entry prize for entering the raffle.

17. The computer program product of claim 12, wherein the third computer readable program code further comprises:
means for causing the computer to enter as raffle participants only interested customers that send the request to enter the raffle within a predetermined period of time.

18. The computer program product of claim 17, further comprising:
means for causing the computer to weight a raffle participant's entry based on when the participant's entry request is received.

19. The computer program product of claim 12, wherein the second and third computer readable program code respectively comprise:
means for causing the computer to receive, from each of a limited number of interested customers, a request to enter the raffle including an authorization to redeem a predetermined number of loyalty rewards points; and
means for causing the computer to redeem, from a loyalty points account associated with each of the limited number of interested customers, the predetermined number of loyalty rewards points, and entering each of the limited number of interested customers as a participant in the raffle.

20. The computer program product of claim 12, wherein the second computer readable program code comprises:
means for causing the computer to receive, from each interested customer, one request to enter the raffle including an authorization to redeem a predetermined number of loyalty rewards points.

21. The computer program product of claim 12, wherein:
the second computer readable program code further comprises fifth computer readable program code means for causing the computer to receive from one or more interested customers, a plurality of requests to enter the raffle, including an authorization to redeem a predetermined number of loyalty reward points for each request; and
the third computer readable program code comprises means for causing the computer to redeem the predetermined number of loyalty rewards points for each request made according to the fifth computer readable program code means, and entering each interested customer as a participant in the raffle a plurality of times corresponding to the plurality of requests.

22. A computer-based method for performing an online raffle, utilizing loyalty rewards points as currency, the method comprising the steps of:
(a) displaying on a website information about items to be raffled, thereby allowing customers to view the information over the Internet using a web browser;
(b) receiving, from each interested customer, a request to enter the raffle including an authorization to redeem a predetermined number of loyalty rewards points;
(c) redeeming, from a loyalty points account associated with each interested customer, the predetermined number of loyalty rewards points, and entering each interested customer as a participant in the raffle; and
(d) selecting, for each item being raffled, a winner from among the raffle participants, wherein each raffle participant is only eligible to win one of the items.

23. The method of claim 22, wherein step (a) further comprises:
(a) displaying on a website information about items to be raffled, thereby allowing customers to view the information over the Internet using a web browser, wherein the items are substantially identical to each other.

24. The method of claim 22, wherein step (a) further comprises:
(a) displaying on a website information about items to be raffled, thereby allowing customers to view the information over the Internet using a web browser, wherein the items are not substantially identical to each other.
